(19) United States
(12) Patent Application Publication
(10) Pub. No.: US 2014/0085410 A1
(43) Pub. Date: Mar. 27, 2014

(54) SYSTEMS AND METHODS OF CREATING A VIRTUAL WINDOW

(71) Applicant: TENEBRAEX CORPORATION, Boston, MA (US)

(72) Inventors: Peter W. J. Jones, Belmont, MA (US); Ellen Cargill, Norfolk, MA (US); Dennis W. Purcell, Medford, MA (US)

(73) Assignee: TENEBRAEX CORPORATION, Boston, MA (US)

(21) Appl. No.: 13/850,812

(22) Filed: Mar. 26, 2013

Related U.S. Application Data
(63) Continuation of application No. 12/384,209, filed on Mar. 31, 2009, now abandoned.
Application No. 12/384,209 is a continuation-in-part of application No. 12/313,274, filed on Nov. 17, 2008, now Pat. No. 8,564,640.
(60) Provisional application No. 61/072,673, filed on Mar. 31, 2008.
(60) Provisional application No. 61/137,002, filed on Jul. 25, 2008.
(60) Provisional application No. 61/003,350, filed on Nov. 16, 2007.

(51) Int. Cl. H04N 5/232

(52) U.S. Cl. CPC H04N 5/23238
USPC 348/36

(57) ABSTRACT

The systems and methods described herein provide imaging systems with multiple imaging sensors arranged in an optical head that create a seamless panoramic view by reducing parallax distortion and adaptively adjusting exposure levels of the recorded images. In particular, an optical head is described with a stacked configuration of CCD imaging sensors in which charge is transferred from a sensor to a processor beginning with an array of photosensitive elements nearest another sensor.

### CROSS-REFERENCE TO RELATED APPLICATIONS

This application is a continuation of U.S. application Ser. No. 12/384,209 filed on Mar. 31, 2009, which claims the benefit of U.S. Provisional Application Ser. No. 61/072,673 filed on Mar. 31, 2008 and U.S. Provisional Application Ser. No. 61/137,002 filed Jul. 25, 2008, and which is a continuation-in-part of U.S. application Ser. No. 12/313,274 filed on Nov. 17, 2008, which claims the benefit of U.S. Provisional Application Ser. No. 61/003,350 filed on Nov. 16, 2007. The teachings of the foregoing applications are hereby incorporated by reference herein in their entirety.

### BACKGROUND

Today, there is a great need for an inexpensive imaging system capable of providing 180- or 360-degree situational awareness through a panoramic (i.e., large-angle) view of a scene. Situational awareness involves perceiving critical factors in the environment or scene. It may include the ability to identify, process, and comprehend the critical elements of information about events occurring in the scene, such as object movement. An imaging system capable of providing situational awareness may be used in battlefield settings to get a real-time view of a combat situation or track movements in hazardous surroundings to better strategize patrolling routes or combat zones.

However, imaging systems that provide panoramic views of a scene may exhibit distortion within the image. Distorted images misrepresent the imaged scene and may lead to incorrect judgments. For example, a distortion of the position of a military target in a battlefield may result in unintended casualties and wasted resources. This is true of devices such as that described by Foote et al. in U.S. Pat. No. 7,277,118, which employs multiple sensors to create the panoramic image and utilizes software techniques for distortion correction.

When two or more imaging sensors are used within an optical head to image a single scene, the distance between their entrance pupils introduces a phenomenon referred to as parallax, in which an object viewed from two different points appears to be in two different positions. In the simplest case of an optical head with two sensors whose pupils are located a distance d from each other, the apparent displacement (also called the parallactic displacement) is given by

$$x = \frac{fd}{o} ,$$

where f is the effective focal length of the lens and o is the distance of the object from the optical head. This calculation can be generalized to three dimensions. In general, parallactic displacement depends upon the relative positions of the entrance pupils of the imaging sensors in the optical head and the relative orientations of their optical axes. Practically, the entrance pupils of the imaging sensors in any physically-realizable distributed imaging system will be separated because of the physical dimensions of the sensor itself. Therefore, all distributed imaging systems will generally experience the parallax phenomenon.

Accordingly, there is a great need for an inexpensive system that provides for a non-distorted image depicting a panoramic view of a scene.

### SUMMARY

The systems and methods described herein provide imaging systems with multiple imaging sensors arranged in an optical head that create a seamless panoramic view by reducing parallax distortion and adaptively adjusting exposure levels of the recorded images. In particular, an optical head is described with a stacked configuration of CCD imaging sensors in which charge is transferred from a sensor to a processor beginning with an array of photosensitive elements nearest another sensor.

In one aspect, the systems and methods described herein include systems for imaging a scene. Such a system may include an optical head including a plurality of imaging sensors arranged in a plurality of rows, each row disposed substantially vertically of an adjacent row and having one or more imaging sensors. In one embodiment, each imaging sensor is capable of imaging an associated horizontal range of the scene, and an associated horizontal range of a first imaging sensor in a row overlaps an associated horizontal range of a second imaging sensor in the row different from the first imaging sensor. In further embodiments, the intersection of a plurality of horizontal ranges associated with a plurality of imaging sensors forms a continuous horizontal range of the scene, which may include a 180-degree or a 360-degree view of the scene. A respective one of said imaging sensors in a first row may have an optical axis lying substantially on a first plane and a respective one of said imaging sensors in a second row may have an optical axis lying substantially on a second plane such that the first plane is substantially parallel to the second plane and the number of imaging sensors in the first row is different from the number of imaging sensors in the second row. In certain embodiments, each row has an associated plane containing the optical axes of the imaging sensors in the row such that the associated plane is parallel to the analogously-defined plane associated with a different row. An optical axis of a first imaging sensor in a selected row may intersect an optical axis of a second imaging sensor in the selected row different from the first imaging sensor.

Certain embodiments of the optical head include three rows of imaging sensors. In one embodiment, a bottom row has two imaging sensors, a middle row has one imaging sensor, and a top row has two imaging sensors. In another embodiment, a rightmost imaging sensor in the bottom row is disposed substantially directly below the one imaging sensor in the middle row, and the one imaging sensor in the middle row is disposed substantially directly below the leftmost imaging sensor in the top row. In another embodiment, the bottom, middle and top rows are horizontally centered with respect to each other.

Such a system may also include a processor connected to the optical head and configured with circuitry for receiving imaging sensor data from each imaging sensor, and generating an image of a scene by assembling the received imaging sensor data. In certain embodiments, each imaging sensor is a charge-coupled device having columns of photosensitive elements. In further embodiments, the system also includes output amplifier circuitry configured for receiving, column-wise, charge accumulated at the photosensitive elements in each sensor; and generating imaging sensor data. In other embodiments, the output amplifier circuitry receives charge from each imaging sensor in a row from a column of photosensitive elements nearest to another imaging sensor in the row.

In a second aspect, the systems and methods described herein include a system for imaging a scene, comprising an optical head including a plurality of imaging sensors, each imaging sensor disposed substantially vertically of another imaging sensor along a vertical axis. In certain embodiments, each imaging sensor is disposed substantially vertically adjacent to another imaging sensor along a vertical axis.

Each imaging sensor may be oriented at a different offset angle about the vertical axis. In one embodiment, a difference in offset angle between two substantially vertically adjacent imaging sensors is the same for any other two substantially vertically adjacent imaging sensors.

Each imaging sensor may have an optical axis that forms a non-zero tilt angle with respect to the vertical axis. In certain embodiments, the tilt angle of an optical axis is about 10 degrees below horizontal. Each of the non-zero tilt angles may be substantially identical. In some embodiments, the intersection of a plurality of horizontal ranges associated with a plurality of imaging sensors forms a continuous horizontal range of the scene, which may include a 180-degree or 360-degree view of the scene.

Such a system may also include a processor connected to the optical head configured with circuitry for receiving imaging sensor data from each imaging sensor, and assembling the received imaging sensor data into an image of a scene.

### BRIEF DESCRIPTION OF THE DRAWINGS

The systems and methods described herein provide imaging systems with multiple imaging sensors arranged in an optical head that create a seamless panoramic view by reducing parallax distortion and adaptively adjusting exposure levels of the recorded images. In particular, an optical head is described with a stacked configuration of CCD imaging sensors in which charge is transferred from a sensor to a processor beginning with an array of photosensitive elements nearest another sensor.

The foregoing and other objects and advantages of the invention will be appreciated more fully from the following further description thereof, with reference to the accompanying drawings wherein;

FIG. 1 depicts an imaging system having two imaging sensors;

FIG. 2 depicts an imaging system for creating a seamless panoramic view having a plurality of imaging sensors in an optical head;

FIG. 3A depicts an a set of unaltered exposure values for multiple imaging sensors;

FIGS. 3B-3D depict various methods for adaptively altering the best exposure value of each image;

FIG. 4A-4C show various embodiments of a display;

FIG. 5 depicts a first optical head having five imaging sensors;

FIG. 6 depicts a second optical head having five imaging sensors;

FIGS. 7A-7B depict top and side views of a single imaging sensor module for use in an optical head;

FIG. 7C depicts a side view of an arrangement of sensor modules in a stacked array to form an optical head;

FIGS. 7D-7E depict top views of two fanned arrangements of multiple imaging sensors in a stacked array;

FIGS. 8A-8C depict a single tilted imaging sensor and various arrangements of such sensors in a stacked array.

### DETAILED DESCRIPTION

The systems and methods described herein will now be described with reference to certain illustrative embodiments. However, the invention is not to be limited to these illustrated embodiments, which are provided merely for the purpose of describing the systems and methods of the invention and are not to be understood as limiting in any way.

In particular, certain embodiments will be discussed which feature a stack of imaging sensors arranged in an optical head. These optical heads may include rows of imaging sensors, with each imaging sensor's orientation chosen so that the optical head can achieve a panoramic field-of-view with minimal parallax distortion. These stacks of imaging sensors may also satisfy geometric requirements, such as minimizing the footprint of the optical head. These embodiments will be discussed in detail along with the structure of imaging systems more broadly.

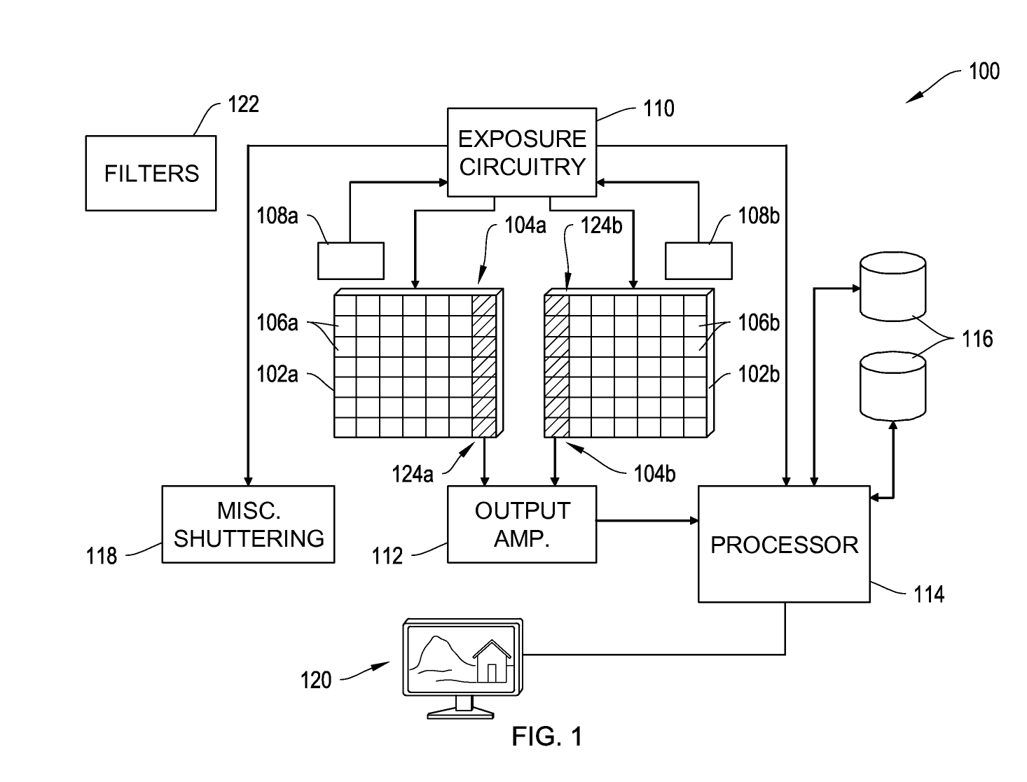

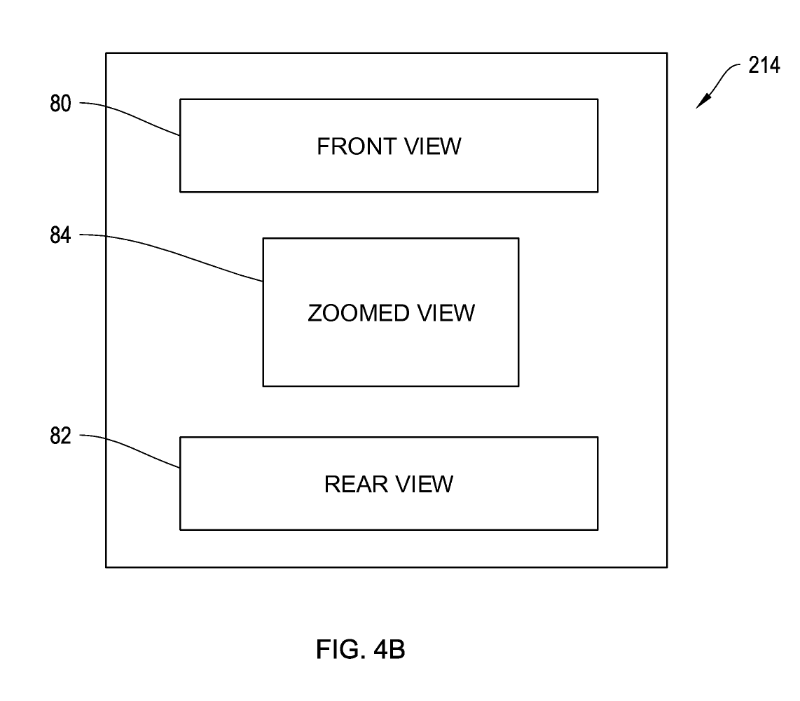

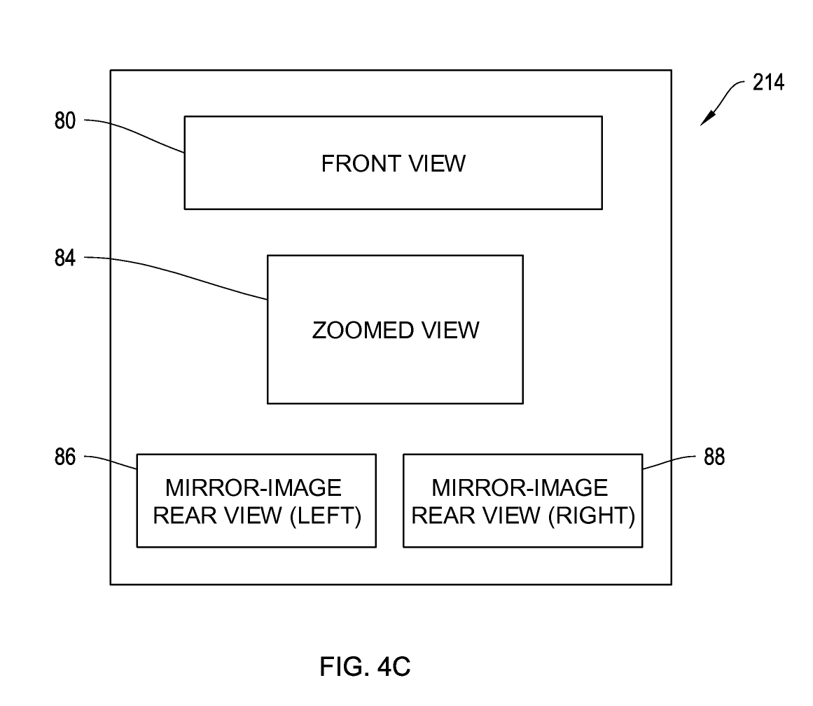

FIG. 1 depicts an imaging system 100 having two sensors positioned adjacent to each other, according to an illustrative embodiment of the invention. In particular, system 100 includes imaging sensors 102a and 102b that are positioned adjacent to each other. Generally, system 100 may include two or more imaging sensors arranged vertically or horizontally with respect to one another without departing from the scope of the invention. For example, system 100 may include five sensors arranged in the configurations shown in FIGS. 5 and 6. Many additional embodiments featuring several exemplary sensors will be discussed in detail with respect to FIGS. 5-8C.

Light meters 108a and 108b are connected to the sensors 102a and 102b for determining incident light on the sensors. The light meters 108a and 108b and the sensors 102a and 102b are connected to exposure circuitry 110. The exposure circuitry 110 is configured to determine an exposure value for each of the sensors 102a and 102b. In certain embodiments, the exposure circuitry 110 determines the best exposure value for a sensor for imaging a given scene. The exposure circuitry 110 is optionally connected to miscellaneous mechanical and electronic shuttering systems 118 for controlling the timing and intensity of incident light and other electromagnetic radiation on the sensors 102a and 102b. The sensors 102a and 102b may optionally be coupled with one or more filters 122. In certain embodiments, filters 122 may preferentially amplify or suppress incoming electromagnetic radiation in a given frequency range.

In certain embodiments, sensor 102a includes an array of photosensitive elements (or pixels) 106a distributed in an array of rows and columns. The sensor 102a may include a charge-coupled device (CCD) imaging sensor. In certain embodiments, the sensor 102a includes a complimentary metal-oxide semiconductor (CMOS) imaging sensor. In certain embodiments, the sensor 102b is similar to the sensor 102a. The sensor 102b may include a CCD and/or CMOS imaging sensor. The sensors 102a and 102b may be positioned adjacent to each other, either vertically or horizontally. The sensors 102a and 102b may be included in an optical head of an imaging system. In certain embodiments, the sensors 102a and 102b may be configured, positioned or oriented to capture different fields-of-view of a scene, as will be discussed in detail below. The sensors 102a and 102b may be angled depending on the desired extent of the field-of-view, as will be discussed further below. During operation, incident light from a scene being captured may fall on the sensors 102a and 102b. In certain embodiments, the sensors 102a and 102b may be coupled to a shutter and when the shutter opens, the sensors 102a and 102b are exposed to light. The light may then converted to a charge in each of the photosensitive elements 106a and 106b.

The sensors can be of any suitable type and may include CCD imaging sensors, CMOS imaging sensors, or any analog or digital imaging sensor. The sensors may be color sensors. The sensors may be responsive to electromagnetic radiation outside the visible spectrum, and may include thermal, gamma, multi-spectral and x-ray sensors. The sensors, in combination with other components in the imaging system 100, may generate a file in any format, such as the raw data, GIF, JPEG, TIFF, PBM, PGM, PPM, EPSF, X11 bitmap, Utah Raster Toolkit RLE, PDS/VICAR, Sun Rasterfile, BMP, PCX, PNG, IRIS RGB, XPM, Targa, XWD, PostScript, and PM formats on workstations and terminals running the X11 Window System or any image file suitable for import into the data processing system. Additionally, the system may be employed for generating video images, including digital video images in the .AVI, .WMV, .MOV, .RAM and .MPG formats.

In certain embodiments, once the shutter closes, light is blocked and the charge may then be transferred from an imaging sensor and converted into an electrical signal. In such embodiments, charge from each column is transferred along the column to an output amplifier 112, a technique referred to as a rolling shutter. The term “rolling shutter” may also be used to refer to other processes which generally occur column-wise at each sensor, including charge transfer and exposure adjustment. Charge may first be transferred from each pixel in the columns 104a and 104b. In certain embodiments, after this is completed, charges from columns 124a and 124b are first transferred to columns 104a and 104b, respectively, and then transferred along columns 104a and 104b to the output amplifier 112. Similarly, charges from each of the remaining columns are moved over by one column towards columns 104a and 104b and the transferred to output amplifier 112. The process may repeat until all or substantially all charges are transferred to the output amplifier 112. In a further embodiment, the rolling shutter's column-wise transfer of charge is achieved by orienting a traditional imaging sensor vertically (i.e., nominally on its side). Additional embodiments of charge transfer methods will be discussed further below. The output amplifier 112 may be configured to transfer charges and/or signals to a processor 114.

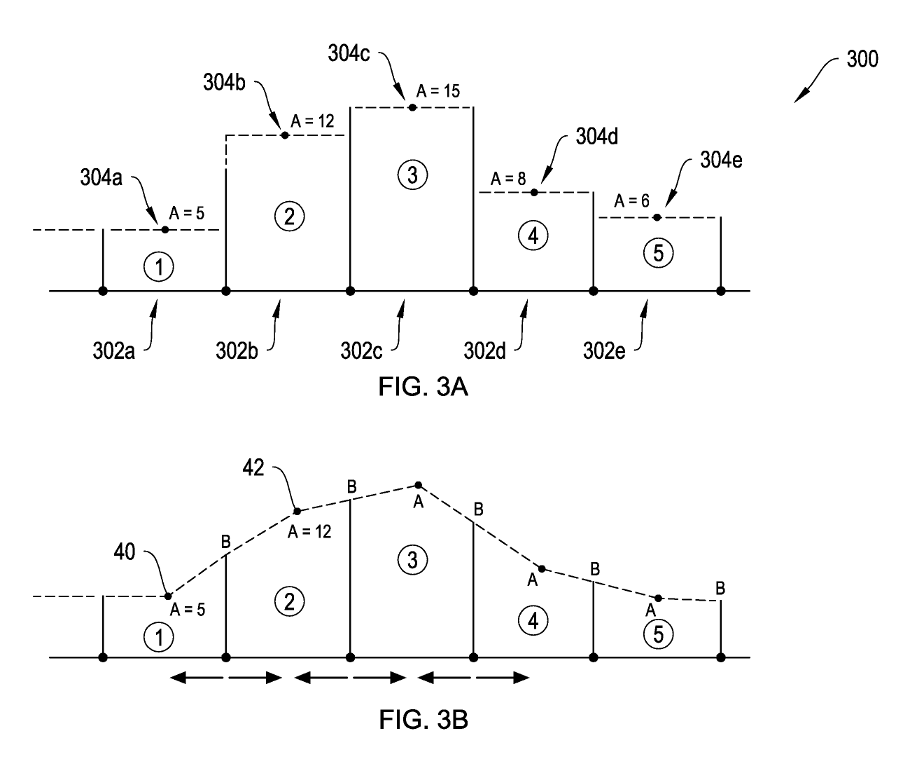

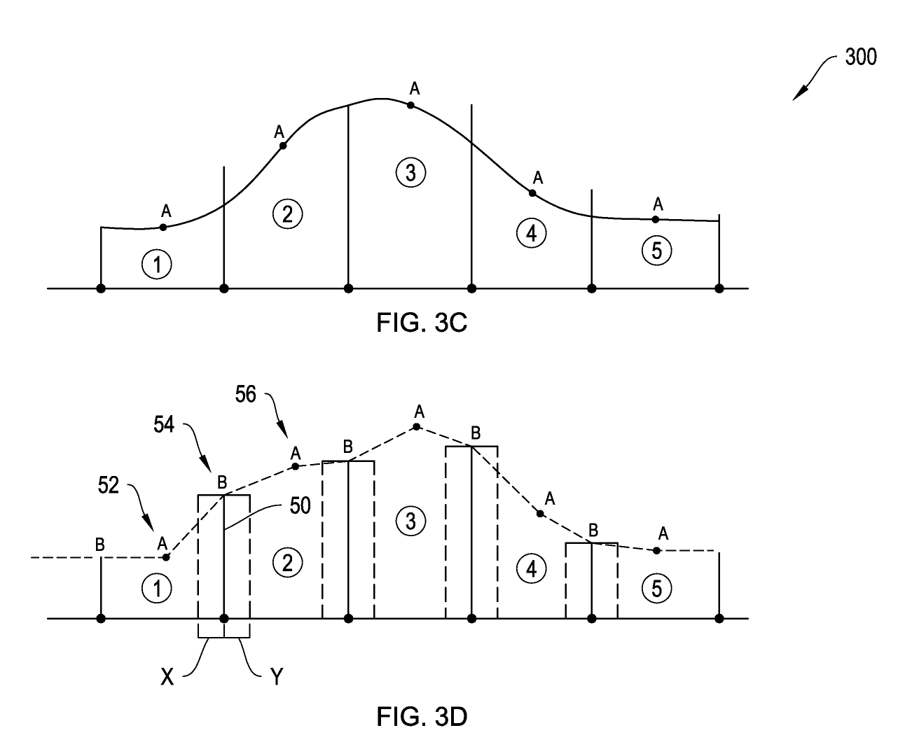

The processor 114 may include microcontrollers and microprocessors programmed to receive data from the output amplifier 112 and exposure values from the exposure circuitry 110, and determine interpolated exposure values for each column in each of the sensors 102a and 102b. Interpolated exposure values are described in more detail with reference to FIGS. 3A-3D. In particular, processor 114 may include a central processing unit (CPU), a memory, and an interconnect bus 606. The CPU may include a single microprocessor or a plurality of microprocessors for configuring the processor 114 as a multi-processor system. The memory may include a main memory and a read-only memory. The processor 114 and/or the databases 116 also include mass storage devices having, for example, various disk drives, tape drives, FLASH drives, etc. The main memory also includes dynamic random access memory (DRAM) and high-speed cache memory. In operation, the main memory stores at least portions of instructions and data for execution by a CPU.

The mass storage 116 may include one or more magnetic disk or tape drives or optical disk drives, for storing data and instructions for use by the processor 114. At least one component of the mass storage system 116, possibly in the form of a disk drive or tape drive, stores the database used for processing the signals measured from the sensors 102a and 102b. The mass storage system 116 may also include one or more drives for various portable media, such as a floppy disk, a compact disc read-only memory (CD-ROM), DVD, or an integrated circuit non-volatile memory adapter (i.e. PC-MCIA adapter) to input and output data and code to and from the processor 114.

The processor 114 may also include one or more input/output interfaces for data communications. The data interface may be a modem, a network card, serial port, bus adapter, or any other suitable data communications mechanism for communicating with one or more local or remote systems. The data interface may provide a relatively high-speed link to a network, such as the Internet. The communication link to the network may be, for example, optical, wired, or wireless (e.g., via satellite or cellular network). Alternatively, the processor 114 may include a mainframe or other type of host computer system capable of communications via the network.

The processor 114 may also include suitable input/output ports or use the interconnect bus for interconnection with other components, a local display 120, and keyboard or other local user interface for programming and/or data retrieval purposes (not shown).

In certain embodiments, the processor 114 includes circuitry for an analog-to-digital converter and/or a digital-to-analog converter. In such embodiments, the analog-to-digital converter circuitry converts analog signals received at the sensors to digital signals for further processing by the processor 114.

The components of the processor 114 are those typically found in imaging systems used for portable use as well as fixed use. In certain embodiments, the processor 114 includes general purpose computer systems used as servers, workstations, personal computers, network terminals, and the like. In fact, these components are intended to represent a broad category of such computer components that are well known in the art. Certain aspects of the invention may relate to the software elements, such as the executable code and database for the server functions of the imaging system 100.

Generally, the methods described herein may be executed on a conventional data processing platform such as an IBM PC-compatible computer running the Windows operating systems, a SUN workstation running a UNIX operating system or another equivalent personal computer or workstation. Alternatively, the data processing system may comprise a dedicated processing system that includes an embedded programmable data processing unit.

Certain of the processes described herein may also be realized as software component operating on a conventional data processing system such as a UNIX workstation. In such embodiments, the processes may be implemented as a computer program written in any of several languages well-known to those of ordinary skill in the art, such as (but not limited to) C, C++, FORTRAN, Java or BASIC. The processes may also be executed on commonly available clusters of processors, such as Western Scientific Linux clusters, which may allow parallel execution of all or some of the steps in the process.

Certain of the methods described herein may be performed in either hardware, software, or any combination thereof, as those terms are currently known in the art. In particular, these methods may be carried out by software, firmware, or microcode operating on a computer or computers of any type, including pre-existing or already-installed image processing facilities capable of supporting any or all of the processor's functions. Additionally, software embodying these methods may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, these methods and systems are not limited to any particular platform, unless specifically stated otherwise in the present disclosure.

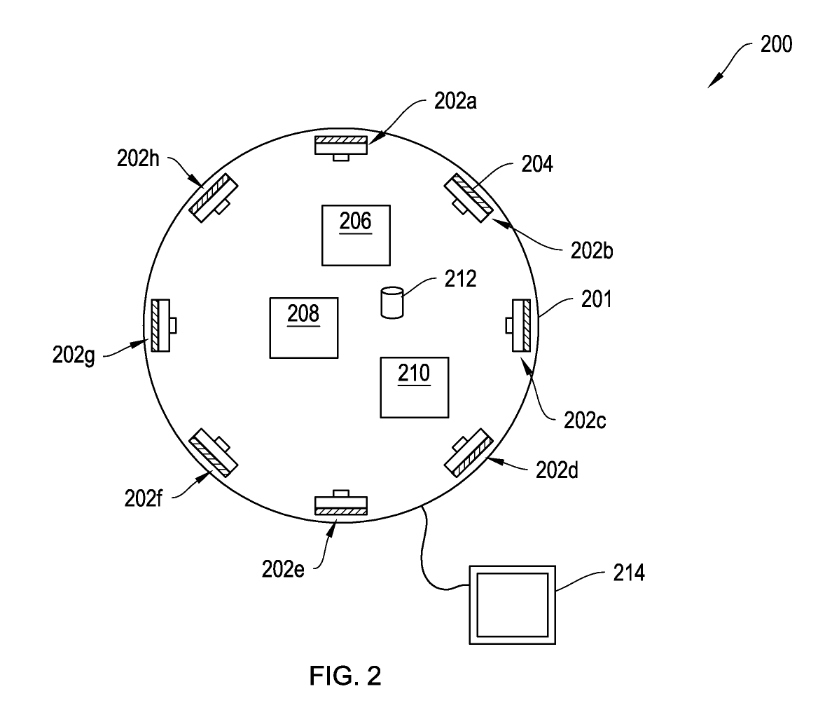

FIG. 2 depicts an imaging system 200 with multiple sensors mounted in an optical head in which each sensor is directed to capture a portion of a panoramic scene. A number of such optical head configurations in accordance with the invention will be discussed in detail below. Each imaging sensor is exposed to a different amount of light and has a different optimum exposure value that best captures the image, sometimes referred to as a best exposure value. An exposure circuitry 206, similar to exposure circuitry 110, determines and assigns the best exposure value for each sensor when the sensor is capturing an image. In some embodiments, the exposure circuitry 206 focuses on the center of a field-of-view captured by the respective sensor when determining the best exposure value for the respective sensor.

In some embodiments, images recorded by the sensors, with each sensor being exposed to a different amount of light, are aligned next to each other. These images may be aligned proximal to each other, or in any number of overlapping arrangements. As a result, when unprocessed images from the multiple sensors are aligned, there exists a discontinuity where the two images meet. The exposures of the images taken by the sensors may be adaptively adjusted to form a seamless panoramic view.

In particular, FIG. 2 depicts one embodiment of system 200 in which a plurality of sensors 202a-202h, similar to the sensors 102a and 102b of FIG. 1, are statically mounted in an optical head 201. Each of the sensors 202a-202h is directed to capture a portion of a scene. FIG. 2 also depicts exposure circuitry 206, a logic/processor 208, a memory 212, a multiplexer 210, and a display 214. Exposure circuitry 206, coupled to the sensors 202a-202h, adjusts the exposure for each sensor, resulting in each sensor recording an image at its best exposure. In some embodiments, the digital signals recorded by the sensors 202a-202h are sent to the multiplexer 210. The logic/processor 208 is in communication with the multiplexer 210. The logic/processor 208, upon receiving data signals from the sensors 202a-202h, accesses the received data signal and adjusts the exposure of each image recorded by the sensors. Digital signals representing a panoramic view may be stored in the memory 212 for further analysis (e.g. for higher-order pattern or facial recognition). After the exposure for each image is adjusted, a view having images joined in a sequential manner is formed and displayed on the display 214. Various methods for adjusting the best exposure values of the images are depicted in FIGS. 3B-3D.

The methods described herein are equally applicable to any of the optical head configurations described herein, including those embodiments illustrated by FIGS. 5-8C. In some embodiments, eight 1.3 megapixel sensors may be mounted in optical head 201 having a diameter of 3 inches. The diameter of optical head 201 may be larger or smaller depending on the application. In some embodiments, multiple imaging sensors are positioned in a closed circle having a combined field-of-view of about 360 degrees. In some embodiments, a plurality of imaging sensors may be positioned in a semi-circle having a combined field-of-view of about 180 degrees. Optical head 201 may be sized and shaped to receive a cover. The cover may have clear windows that are sized and positioned to allow the sensors to capture a panoramic image. Imaging system 200 may be connected to a display (e.g., a laptop monitor) through a USB interface.

As noted earlier, generally, when an image is projected to a capacitor array of a CCD sensor, each capacitor accumulates an electric charge proportional to the light intensity at the location of its field-of-view. A control circuit then causes each capacitor to transfer its contents to the adjacent capacitor. The last capacitor in the array transfers its charge into an amplifier that converts the charge into a voltage. By repeating this process for each row of the array, the control circuit converts the entire contents of the array to a varying voltage and stores in a memory.

In some embodiments, the multiple sensors (e.g., sensors 202a-202h) record images as though they were one sensor. A first row of a capacitor array of a first sensor accumulates an electric charge proportional to its field-of-view and a control circuit transfers the contents of each capacitor array to its neighbor. The last capacitor in the array transfers its charge into an amplifier. Instead of moving to a second row of the array, in some embodiments, a micro-controller included in the system causes the first row of the capacitor array of the adjacent sensor (e.g., sensor 202d if the first sensor was sensor 202c) to accumulate an electric charge proportional to its field-of-view.

The logic/processor 208 may comprise any of the commercially available micro-controllers. The logic/processor 208 may execute programs for implementing the image processing functions and the calibration functions, as well as for controlling the individual system, such as image capture operations. Optionally, the micro-controllers can include signal processing functionality for performing the image processing, including image filtering, enhancement and for combining multiple fields-of-view.

FIG. 3A shows an example 300 of the best exposure values of five imaging sensors 302a-302e. FIG. 3A may also be illustrative of the best exposure values of the five imaging sensors depicted in FIGS. 5 and 6, or any of the optical head configurations described herein. The number of exposure values is purely illustrative, and any number would be equally amenable to the methods described herein. Points 304a-304e represent the best exposure values for each sensor. For example in FIG. 3A, a best exposure value for frame 1, corresponding to sensor 302a, is 5. A best exposure value for frame 2, corresponding to sensor 302b, is 12. The images may appear truncated without adjusting the exposure of the images. FIGS. 3B-3D depict various methods for adaptively adjusting the best exposure values of the images.

FIG. 3B depicts linear interpolation between the best exposures of each sensor. An optimal exposure for each camera remains in the center of the frame and is linearly adjusted from a center of a frame to a center of an adjacent frame. For example, if frame 1 has a best exposure value of 5 (at point 40) and frame 2 has 12 (at point 42), the exposure values between the two center points (40 and 42) are linearly adjusted to gradually control the brightness of the frames. The exposure values between two center points 40 and 42 start at 5 and increase up to 12 linearly. With such a method, there may be some differences in brightness at the centers of each frame.

FIG. 3C depicts an alternative method for adjusting exposure values across the images. Similar to FIG. 2B, an optimal exposure for each camera remains in the center of the frame. In FIG. 3C, a spline interpolation between the best exposure values at the centers of the frames is shown, resulting in a panoramic view having fewer discontinuities or abrupt changes across the images.

FIG. 3D depicts yet another method for adjusting the best exposure value of each sensor. Best exposure values across seams (e.g., seam 50) are averaged. In some embodiments, a fraction of a length of a frame (e.g., 20% of the frame width) on both sides of a seam may be used to compute the average best exposure value for a seam. The best exposure value at the seam is adjusted to a calculated average best exposure. For example, in FIG. 3D, frame 1 has a best exposure value of 5 in zone X and frame 2 has a best exposure value of 11 in zone Y. The average of the best exposure values across seam 50 is 8. The best exposure value at seam 50 is adjusted to 8. The linear interpolation method as depicted in FIG. 3B may be used to linearly adjust the exposure values between point 52 and point 54 and between point 54 and point 56, etc. The result is a more gradual change of brightness from one frame to a next frame. In other embodiments, the spline interpolation method as depicted in FIG. 3C may be used to adjust the best exposure values between the same points (points 52-54).

In certain embodiments, an interpolated exposure value of the column in the first sensor nearest to the second sensor is substantially the same as an interpolated exposure value of the column in the second sensor nearest to the first sensor. One or more interpolated exposure values may be calculated based on a linear interpolation between the first and second exposure values. One or more interpolated exposure values may be calculated based on a spline interpolation between the first and second exposure values. In certain embodiments, at least one column in the first sensor has an exposure value equal to the first exposure value and at least one column in the second sensor has an exposure value equal to the second exposure value.

In certain embodiments, the methods may include disposing one or more additional charge-coupled device imaging sensors adjacent to at least one of the first and second sensor. In such embodiments, recording the image includes exposing the one or more additional sensors at a third exposure value and determining interpolated exposure values for columns between the one or more additional sensors and the first and second sensors based on the first, second and third exposure values.

In certain embodiments, a panoramic window is formed by a plurality of imaging sensors. The panoramic window may include a center window and steering window. The center window may tell a viewer where the center of the panoramic image is. In some embodiments, the center of a panoramic view is an arbitrarily selected reference point which establishes a sense of direction or orientation. Since a person's ability to interpret a 360-degree view may be limited, noting the center of a panoramic view helps a viewer determine whether an image is located to the right or left of a reference point.

In some embodiments, a separate screen shows the area enclosed by steering window. The separate screen may be a zoomed window showing a portion of the panoramic image. The steering window may be movable within panoramic window. The zoomed window may show the image contained in the steering window at a higher resolution. In this embodiment, a user wanting to get a closer look at a specific area may move the steering window to the area of interest within the panoramic window to see an enlarged view of the area of interest in the zoomed window. The zoomed window may have the same pixel count as the panoramic window. In some embodiments, the zoomed window may have a higher pixel count than the panoramic window.

The optical head may be a CCD array of the type commonly used in the industry for generating a digital signal representing an image. In some embodiments, the optical head takes an alternate sensor configuration, including those depicted in FIGS. 5-8C. The CCD digital output is fed into a multiplexer. In some embodiments, the multiplexer 210 receives data signals from the sensors in the optical head at low and high resolution. The data signal received at a low resolution forms the image shown in the panoramic window. The data signal received at a high resolution is localized and only utilized in the area that a user is interested in. Images selected by a steering window use the data signal received at a high resolution. The embodiments described herein allow an instant electronic slewing of high-resolution zoom windows without moving the sensors.

If the system used 3 megapixel sensors instead of 1.3 megapixel, even with a smaller steering window, the area selected by the steering window would show the selected image at a higher resolution. This image data may be transferred by the multiplexer 210 to the memory 212. In some embodiments, the image presented in the zoomed window may be stored in a memory for later processing.

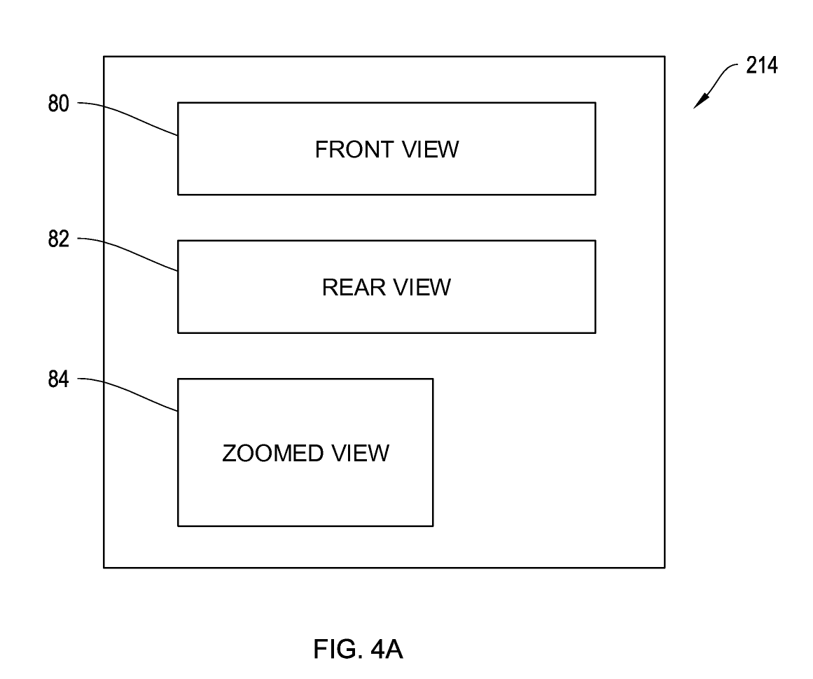

In some embodiments, it may be helpful to split a 360-degree view into two 180-degree views: a front view and a rear view. For example, a 360-degree view having 1064×128 pixels may be split into two 532×128 pixel views. FIG. 4A-4B show different embodiments of a display (e.g., the display 214 of FIG. 2) having three windows: a front-view window 80, a rear-view window 82, and a zoomed window 84. The windows may be arranged in any logical order. In FIG. 4A, the windows are vertically arranged with the front-view window 80 at the top, the rear-view window 82 in the middle, and the zoomed window 84 at the bottom. In FIG. 4B, the zoomed window 84 may be positioned between the front-view window 80 and the rear-view window 82.

In some embodiments, a mirror image of a rear-view image may be shown in a rear-view window since most people are accustomed to seeing views that they cannot see using mirrors such as a rear-view mirror in a car. FIG. 4C depicts the display 214 with two windows showing mirror-image rear views (86 and 88). In this embodiment, the rear view captured by the imaging sensors is divided into left and right rear views. However, in other embodiments, the mirror-image rear views may be presented in a single window.

Having addressed certain illustrative embodiments of imaging systems, systems and methods for reducing parallax distortion will now be described. As discussed above, parallax distortion results from separation of the entrance pupils of the individual imaging sensors, and generally depends upon the location of the entrance pupils and the relative orientations of the axes through each of the entrance pupils (referred to as the optical axes). The choice of an appropriate arrangement depends on many factors, including, among other things, distortion reduction, ease of manufacturing, size of the resulting optical head, mechanical and electrical connection limitations, and application-specific limitations. A common practice for arranging multiple imaging sensors in an optical head for producing a panoramic image of a scene is to arrange them side-by-side into a fanned array, in which the optical axes are radial to a point. Such an embodiment, as depicted in FIG. 2, has advantageous distortion properties. However, many applications require an optical head with a small physical footprint. The physical footprint of a device generally refers to a dimension of the device, e.g. the area of the base of the device or the vertical height of the device. Considering an optical head's physical footprint is important in many applications with size and position constraints. For example, optical heads that are to be mounted in narrow places, such as the corner of a room or within a rack of surveillance equipment, will preferentially have a correspondingly small base.

In certain embodiments, imaging sensors in an optical head are arranged both horizontally and vertically in order to minimize parallax distortion while satisfying geometrical and mechanical constraints on the optical head.

FIG. 5 depicts a first optical head 500 having five imaging sensors 501a-501e, according to an illustrative embodiment. Such an optical head can be readily used in an imaging system such as the system 200 or the system 100. In some embodiments, the imaging sensors in the optical head are arranged so that the configuration exhibits minimum total parallax for all of the combinations of imaging sensors when taken pair-wise. The arrangement of the imaging sensors 501a-501e in the optical head 500 of FIG. 5 is one configuration that satisfies this minimum total parallax condition in accordance with the present invention. In some embodiments, the imaging sensors in the optical head are positioned so that the distance between their entrance pupils is minimized (e.g. entrance pupils 502a and 502b for imaging sensors 501a and 501b, respectively) when compared to the footprint of the optical head 500. The particular embodiment illustrated in FIG. 5 also satisfies this criterion. In some embodiments, more or fewer than five imaging sensors may be arranged to satisfy this criterion. In other embodiments, the imaging sensors are arranged so that the distance between their entrance pupils is minimized when compared to another geometric or mechanical constraint on the optical head 500, such as the height of the optical head 500, the volume of the optical head 500, the shapes of the imaging sensors comprising the optical head 500, an angular limitation on the orientations of the imaging sensors (e.g., the imaging sensors 501a-501e), or the manufacturability of the optical head 500. In some embodiments, the imaging sensors are arranged so that the configuration exhibits minimum total parallax for all pairs of adjacent imaging sensors. Two imaging sensors may be considered adjacent when they are, for example, horizontally abutting, vertically abutting, within a given proximity of each other or disposed proximally as part of a regular pattern of imaging sensors.

In some embodiments, the optical head includes imaging sensors arranged in rows. In further embodiments, each row of imaging sensors is disposed substantially vertically of another row. For example, the optical head 500 includes a first row of sensors (e.g., sensor 501d and sensor 501e), a second row of sensors (e.g., sensor 501b) and a third row of sensors (e.g., sensor 501a and sensor 501c). In certain embodiments, an optical head has two rows of imaging sensors in which the optical axes of the sensors in the first row lie substantially on a first plane and the optical axes of the sensors in the second row lie substantially on a second plane. In certain embodiments, the first plane is substantially parallel to the second plane. Additionally, the number of imaging sensors in the first and second row may be different. The optical head 500 has rows of imaging sensors satisfying these criteria. For example, a first row of sensors including the sensor 501d and the sensor 501e has optical axes that form a plane, with that plane being substantially parallel to a plane containing the optical axes of the sensors in a second row (e.g., the sensor 501b). In certain embodiments, each row corresponds to such a plane, and all such planes are substantially parallel. In some embodiments, two rows are able to image different horizontal ranges of the scene, and these horizontal ranges may overlap.

FIG. 6 depicts a second optical head having five imaging sensors, according to an illustrative embodiment of the invention. The arrangement of the imaging sensors 601a-601e in the optical head 600 is another configuration in accordance with the present invention that satisfies the minimum total parallax condition described above. In some embodiments of the present invention, the imaging sensors in the optical head are further arranged so that the configuration introduces parallax in one dimension only for adjacent camera modules. This requirement allows for simpler parallax correction when the composite image is created, for example, by processor 114 or an external computing device connected via a communications interface as described above. The arrangement of the imaging sensors 601a-601e in the optical head 600 is one configuration in accordance with the present invention that satisfies this one-dimensional parallax requirement. More or fewer than five imaging sensors may be arranged to satisfy this criterion. In other embodiments, the imaging sensors are arranged to satisfy the one-dimensional parallax requirement while satisfying a geometric or mechanical constraint on the optical head 600, such as the height of the optical head 600, the volume of the optical head 600, the shapes of the imaging sensors comprising the optical head 600, an angular limitation on the orientations of the imaging sensors, or the manufacturability of the optical head 600.

The sensors 601a-601e of the optical head 600 of FIG. 6 can be identified as distributed through three rows of sensors; a bottom row including the sensors 601a and 601b, a middle row including the sensor 601c and a top row including the sensors 601d and 601e. In some embodiments, a rightmost imaging sensor in the bottom row is disposed substantially directly below one imaging sensor in the middle row, and the one imaging sensor in the middle row is disposed substantially directly below the leftmost imaging sensor in the top row.

FIGS. 5 and 6 depict optical heads with wide composite fields-of-view, achieved by assembling the images produced by each of the imaging sensors 501a-501e and 601a-601e, respectively. In some embodiments, the horizontal range of the field-of-view of the optical head will be about 180 degrees. In some embodiments, the horizontal range of the optical head will be 360 degrees. In general, the imaging sensors may be arranged to achieve any horizontal field-of-view that encompasses a particular scene of interest.

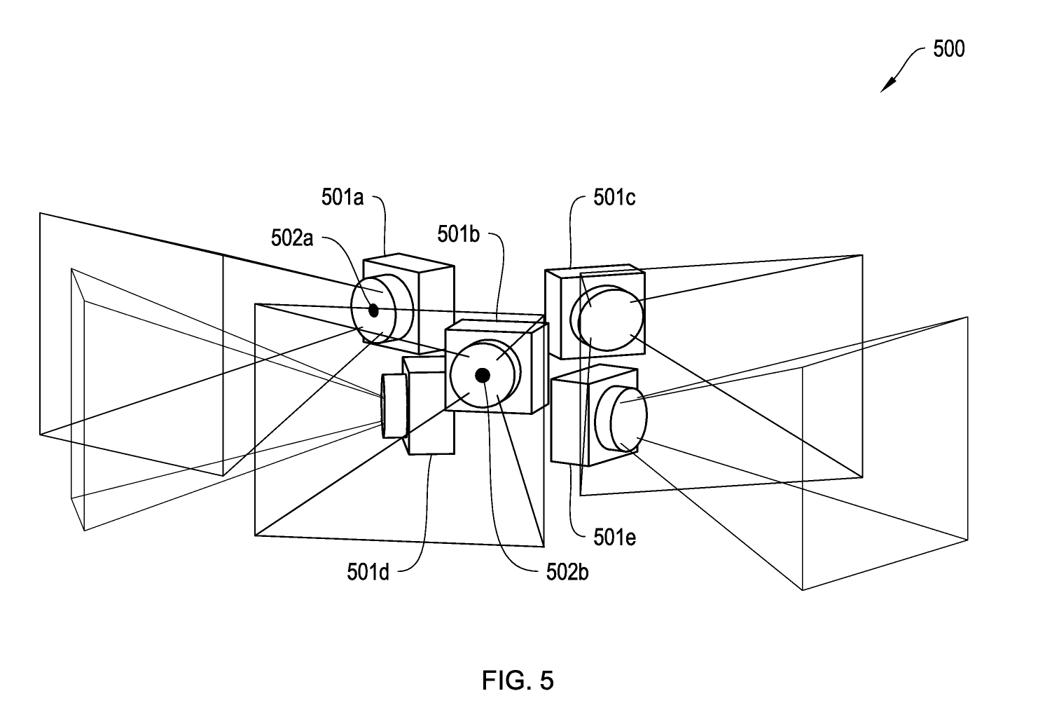

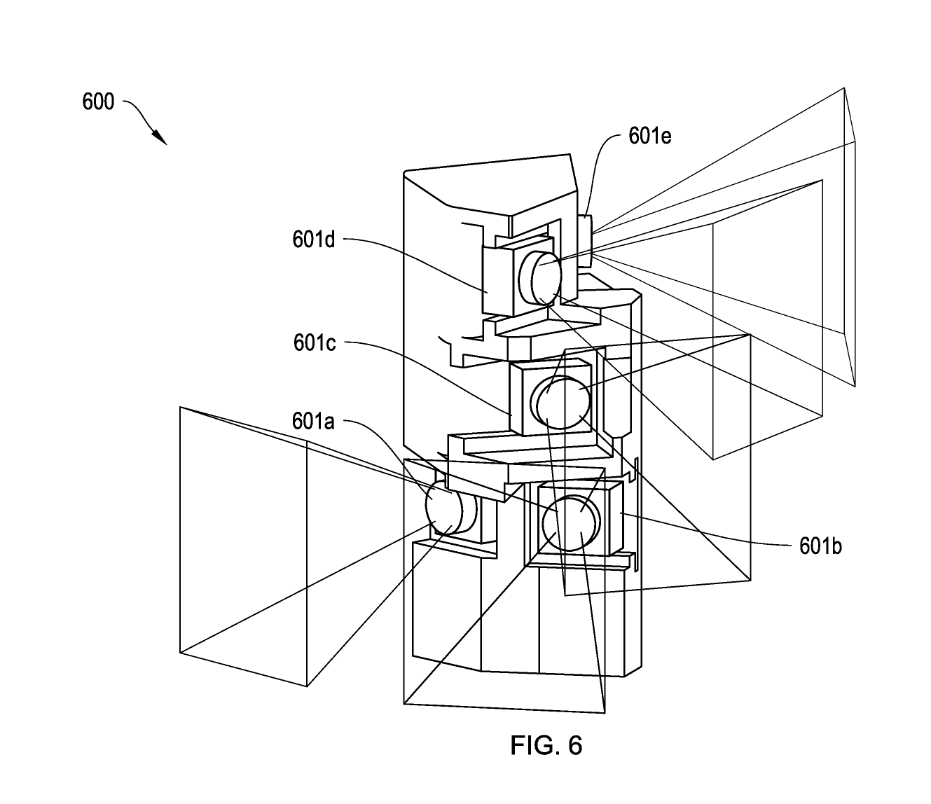

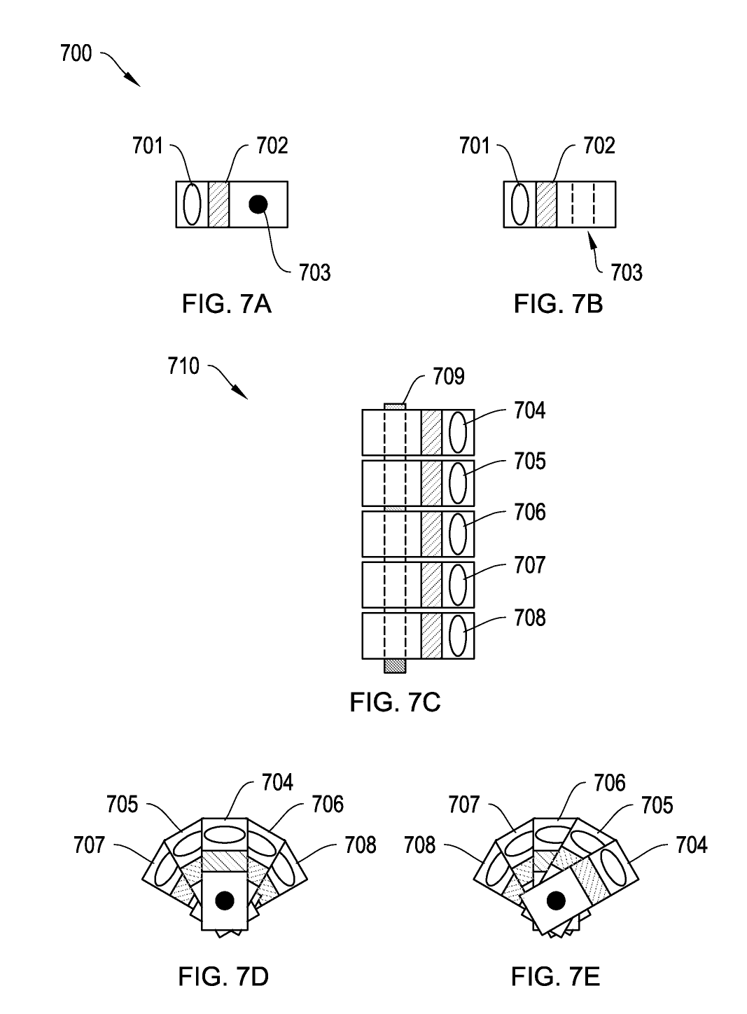

FIGS. 7A-7B depict top and side views of a single imaging sensor module 700 for use in an optical head, according to an illustrative embodiment of the invention. The top view of the sensor module of FIG. 7A includes an imaging sensor 701 mounted within a module body 702. The imaging sensor 701 may be any of a variety of types of imaging sensors, such as those described with reference to the imaging sensors 102a, 102b and 202a-202h above. The imaging sensor 701 may also include more than one imaging sensor, each of which may be positioned at a particular angle and location within the module body 702. The module body 702 of FIG. 7A also includes a hole 703, which may be used for assembling multiple sensor modules into an optical head, as will be discussed below. In some embodiments, the module body 702 may not include a hole, and may include mechanical connection mechanisms for assembling multiple sensor modules into an optical head. In some embodiments, each module body 702 may include mechanical connection mechanisms for attaching two sensor modules to each other, such as interlocking mounting pins.

The sensor module 700 may include circuitry for controlling the imaging sensor 701, processing circuitry for receiving image data signals from the imaging sensor 701, and communication circuitry for transmitting signals from the imaging sensor 701 to a processor, for example, the processor 114. Additionally, each module body 702 may include movement mechanisms and circuitry to allow the sensor module 700 to change its position or orientation. Movement of the sensor module 700 may occur in response to a command issued from a central source, like processor 114 or an external device, or may occur in response to phenomena detected locally by the sensor module 700 itself. In one embodiment, the sensor module 700 changes its position as part of a dynamic reconfiguration of the optical head in response to commands from a central source or an external device. In another embodiment, the sensor module 700 adjusts its position to track a moving object of interest within the field-of-view of the imaging sensor 701. In another embodiment, the sensor module 700 adjusts its position according to a schedule. In other embodiments, only the imaging sensor 701 adjusts its position or orientation within a fixed sensor module 700. In further embodiments, both the sensor module 700 and the imaging sensor 701 are able to adjust their positions.

FIG. 7C depicts a side view of an arrangement of sensor modules in a stacked array to form an optical head 710, according to an illustrative embodiment of the invention. The imaging sensors 704-708 are disposed vertically adjacent to one another when the optical head 710 is viewed from the side. In the embodiment of FIG. 7C, a mounting rod 709 runs through the hole 703 in each module body. In some embodiments, each sensor module 700 can be rotationally positioned when mounted on the mounting rod 709 at an offset angle from an arbitrary reference point. In some embodiments, each of the sensor modules can be locked in position on the mounting rod 709, either temporarily or permanently. In some embodiments, the optical head 710 is reconfigurable by repositioning each sensor module 700. In some embodiments, each sensor module 700 is capable of being rotationally positioned about a longitudinal optical head axis without the use of a mounting rod 709. This longitudinal axis may be horizontal, vertical, or any other angle. The depiction of five sensor modules 704-708 in FIG. 7C is merely illustrative, and any number of sensor modules may be used in accordance with the invention.

FIGS. 7D-7E depict top views of two fanned arrangements of multiple imaging sensors in a stacked array, according to illustrative embodiments of the invention. In these embodiments, a wide composite field-of-view is achieved by assembling the images produced by each of the imaging sensors 704-708 which are oriented at various offset angles. In some embodiments, the horizontal field-of-view of the optical head will be about 180 degrees. In some embodiments, the horizontal field-of-view of the optical head will be 360 degrees. In some embodiments, the sensor modules 704-708 will be arranged to achieve a horizontal field-of-view that encompasses a particular scene of interest.

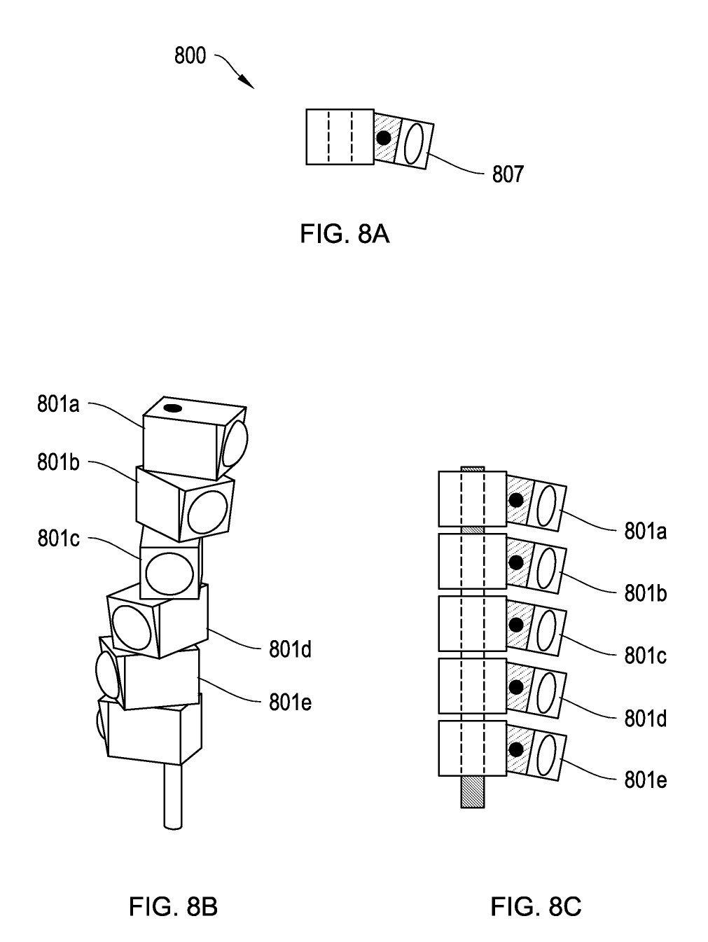

FIGS. 8A-8C depict a single tilted imaging sensor and various arrangements of such sensors in a stacked array, according to illustrative embodiments of the invention. For certain surveillance applications, such as an optical head that is to be mounted high up and which needs to look downwards, each individual sensor module 800 can be constructed such that the imaging sensor 807 has a downwards tilt at a tilt angle. Such an imaging sensor module 800 is depicted in FIG. 8A. The imaging sensor module 800 may include the same components as the sensor module 700.

FIGS. 8B-8C depict side views of a stack of imaging sensor modules 801a-801e forming an optical head 810 according to two embodiments. In these embodiments, the optical head 810 has a downwards angle of view. At the same time, the imaging sensors 801a-801e that point to the sides maintain a horizontal horizon line. This is depicted in the side view of the optical head 810 of FIG. 8C. In some embodiments, an individual sensor module 800 has an imaging sensor 807 with an upwards tilt. The tilt angle of a sensor module 800 can be any angle suitable for a desired application. In some embodiments, the tilt angles of each individual sensor module 800 in an optical head 810 are identical. In one embodiment, the tilt angle of the sensor module 800 is approximately 10 degrees below horizontal. In some embodiments, the tilt angles of each individual sensor module 800 are chosen so that the optical head 810 has a field-of-view including a vertical angular range.

The system described herein provides a constant 360-degree situational awareness. One application of the system may be in the use of a robot, which can include such a system to scout an area of interest without human intervention. The robot may be sent to monitor a cleared area after military operations. The system may also be able to operate in low-light situations with the use of a set of black and white and non-infrared filtered sensors. The non-infrared filtered sensors may be co-mounted in an optical head (e.g., the optical head 201 of FIG. 2 or the optical head 500 of FIG. 5). The system may automatically transition between the non-infrared filtered sensors and the sensors described with respect to FIG. 2 or FIG. 5. The system may be controlled by software to switch between the low light and full light settings. With non-infrared sensors, the robot may patrol an area post sun-set.

As mentioned above with reference to FIG. 1, a typical charge-coupled device (CCD) imaging sensor (for example, imaging sensor 102a or 501a) may consist of parallel vertical CCD shift registers, a serial horizontal CCD shift register, and a signal-sensing output amplifier. During operation, sequential rows of charges in the photosensitive elements (pixels) in the vertical CCD (e.g., either of imaging sensors 102a or 102b) are shifted in parallel to the horizontal CCD, where they are transferred serially as the horizontal lines of the image and read by the output amplifier. The process repeats until all rows are read out of the sensor array.

According to an embodiment of the invention, a plurality of CCD imaging sensors are rotated by 90-degrees so that the charge in each pixel is transferred column-wise until all the columns are read out. This column-wise charge transfer acts as a rolling shutter. In some embodiments, as each column is read out, the signal value or charge may be modified based on an interpolated exposure value as described above.

For example, FIG. 6 depicts the imaging sensor 601a disposed horizontally adjacent to the imaging sensor 601b. In such a configuration, the rolling shutter may begin at a border column, with charge collected at each of the photosensitive elements in the imaging sensor 601a transferred column-wise to a processor beginning with a border column nearest the imaging sensor 601b. Charge collected at each of the photosensitive elements in the imaging sensor 601b may also be transferred column-wise to a processor, such as the processor 114, beginning with a border column nearest the imaging sensor 601a.

In another example of an alternative rolling shutter, FIG. 6 depicts the imaging sensor 601b disposed vertically adjacent to the imaging sensor 601c. In such a configuration, charge collected at each of the photosensitive elements in the imaging sensor 601b may be transferred row-wise to a processor beginning with a border row nearest the imaging sensor 601c. Charge collected at each of the photosensitive elements in the imaging sensor 601c may also be transferred row-wise to a processor, such as the processor 114, beginning with a border row nearest the imaging sensor 601b.

In both of the above examples, transferring charge may further include a rolling shutter in which charge is transferred to the processor from the remaining columns in the imaging sensor 601a sequentially away from the border column of the imaging sensor 601a. In certain embodiments, transferring charge may still further include transferring, to the processor, charge from the remaining columns in the imaging sensor 601b sequentially away from the border column of the imaging sensor 601b. In another embodiment, the rolling shutter may include transferring charge from a column furthest away from a border column first, followed by transferring charge from a column nearer to the border column. The charge transfer methods as described readily apply to any of the optical head configurations described herein, including those depicted in FIGS. 1, 2 and 5-8C.

Those skilled in the art will know or be able to ascertain using no more than routine experimentation, many equivalents to the embodiments and practices described herein. Variations, modifications, and other implementations of what is described may be employed without departing from the spirit and scope of the invention. More specifically, any of the method, system and device features described above or incorporated by reference may be combined with any other suitable method, system or device features disclosed herein or incorporated by reference, and is within the scope of the contemplated inventions. The systems and methods may be embodied in other specific forms without departing from the spirit or essential characteristics thereof. The foregoing embodiments are therefore to be considered in all respects illustrative, rather than limiting of the invention. The teachings of all references cited herein are hereby incorporated by reference in their entirety.

What is claimed is:

1. A system for imaging a scene, comprising:
an optical head including a plurality of imaging sensors arranged in a plurality of rows, each row disposed substantially vertically of an adjacent row and having one or more imaging sensors, wherein:
a respective one of said imaging sensors in a first row has an optical axis lying substantially on a first plane and a respective one of said imaging sensors in a second row has an optical axis lying substantially on a second plane such that the first plane is substantially parallel to the second plane and the number of imaging sensors in the first row is different from the number of imaging sensors in the second row,
an optical axis of a first imaging sensor in a selected row intersects an optical axis of a second imaging sensor in the selected row different from the first imaging sensor; and
a processor connected to the optical head and configured with circuitry for:
receiving imaging sensor data from each imaging sensor, and
generating an image of a scene by assembling the received imaging sensor data.

2. The system of claim 1, wherein each imaging sensor is capable of imaging an associated horizontal range of the scene, and an associated horizontal range of a first imaging sensor in a row overlaps an associated horizontal range of a second imaging sensor in the row different from the first imaging sensor.

3. The system of claim 1, wherein each imaging sensor is capable of imaging an associated horizontal range of the scene, and the intersection of a plurality of horizontal ranges associated with a plurality of imaging sensors forms a continuous horizontal range of the scene.

4. The system of claim 3, wherein the continuous horizontal range comprises a 180-degree view of the scene.

5. The system of claim 1, wherein a bottom row has two imaging sensors, a middle row has one imaging sensor, and a top row has two imaging sensors.

6. The system of claim 5, wherein a rightmost imaging sensor in the bottom row is disposed substantially directly below the one imaging sensor in the middle row, and the one imaging sensor in the middle row is disposed substantially directly below the leftmost imaging sensor in the top row.

7. The system of claim 5, wherein the bottom, middle and top rows are horizontally centered with respect to each other.

8. The system of claim 1, wherein each imaging sensor is a charge-coupled device having columns of photosensitive elements.

9. The system of claim 8, further comprising output amplifier circuitry configured for receiving, column-wise, charge accumulated at the photosensitive elements in each sensor; and generating imaging sensor data.

10. The system of claim 9, wherein the output amplifier circuitry receives charge from each imaging sensor in a row from a column of photosensitive elements nearest to another imaging sensor in the row.

11. The system of claim 1, wherein each row has an associated plane containing the optical axes of the imaging sensors in the row such that the associated plane is parallel to the analogously-defined plane associated with a different row.

12. A system for imaging a scene, comprising:
an optical head including a plurality of imaging sensors, each imaging sensor disposed substantially vertically of another imaging sensor along a vertical axis and each oriented at a different offset angle about the vertical axis, wherein each imaging sensor has an optical axis that forms a non-zero tilt angle with respect to the vertical axis, and wherein each of the non-zero tilt angles is substantially identical; and
a processor connected to the optical head configured with circuitry for
receiving imaging sensor data from each imaging sensor, and
assembling the received imaging sensor data into an image of a scene.

13. The system of claim 12, wherein each imaging sensor is disposed substantially vertically adjacent to another imaging sensor along a vertical axis.

14. The system of claim 13, wherein a difference in offset angle between two substantially vertically adjacent imaging sensors is the same for any other two substantially vertically adjacent imaging sensors.

15. The system of claim 12, wherein the tilt angle is about 10 degrees below horizontal.

16. The system of claim 12, wherein the intersection of a plurality of horizontal ranges associated with a plurality of imaging sensors forms a continuous horizontal range of the scene.

17. The system of claim 16, wherein the continuous horizontal range comprises a 180-degree view of the scene.
